(19) United States
(12) Patent Application Publication
(10) Pub. No.: US 2023/0307614 A1
(43) Pub. Date: Sep. 28, 2023

(54) LITHIUM-ION BATTERY AND ELECTRIC VEHICLE

(71) Applicant: BYD COMPANY LIMITED, Shenzhen (CN)

(72) Inventors: Riguo MEI, Shenzhen (CN); Zhengjiao LIU, Shenzhen (CN); Xiaoya CHANG, Shenzhen (CN); Ziwen WU, Shenzhen (CN); Yi PAN, Shenzhen (CN)

(21) Appl. No.: 18/205,175

(22) Filed: Jun. 2, 2023

Related U.S. Application Data
(63) Continuation of application No. PCT/CN2021/135420, filed on Dec. 3, 2021.

(30) Foreign Application Priority Data
Dec. 4, 2020 (CN) 202011401161.3

(51) Int. Cl. H01M 4/36; H01M 10/0525; H01M 10/42; H01M 4/40; H01M 10/0585

(52) U.S. Cl. CPC H01M 4/366; H01M 10/0525; H01M 10/4235; H01M 4/405; H01M 10/0585; H01M 2220/20; H01M 2004/021

(57) ABSTRACT

A lithium-ion battery includes a cell including N battery unit, and at least one negative electrode lithium replenishing agent film that includes an independent lithium replenishing electrode including a current collector and a first metal lithium layer disposed on the current collector, or includes a second metal lithium layer laminated on a surface of a negative electrode material layer. An areal density σ of the metal lithium layer and a parameter θ satisfy certain relationships. Each of the N battery units includes a positive electrode plate, a negative electrode plate, and a separator sandwiched between the positive electrode plate and the negative electrode plate. The positive electrode plate comprises a positive electrode current collector and a positive electrode material layer disposed on the positive electrode current collector. The negative electrode plate includes a negative electrode current collector and a negative electrode material layer disposed on the negative electrode current collector.

### CROSS-REFERENCE TO RELATED APPLICATIONS

This application is a Continuation application of International Patent Application No. PCT/CN2021/135420, filed on Dec. 3, 2021, which is based on and claims priority to and benefits of Chinese Patent Application No. 202011401161.3, filed on Dec. 4, 2020. The entire content of all of the above-referenced applications is incorporated herein by reference.

### FIELD

The present disclosure relates to the technical field of lithium-ion batteries, and in particular, to a lithium-ion battery and an electric vehicle.

### BACKGROUND

Lithium-ion batteries are widely used in portable electronic devices (such as mobile phones, tablet computers, etc.), unmanned aerial vehicles, electric vehicles and other fields because of the high energy density, small size, and no memory effect. However, lithium-ion batteries also have their own disadvantages, such as capacity fading. The loss of active lithium is one of the main reasons for the capacity fading of lithium-ion batteries during the cycle. Therefore, measures taken in the industry are generally to add a lithium replenishing agent capable of providing active lithium to the lithium-ion battery system in advance to make up for the irreversible loss of active lithium.

At present, mature lithium replenishing technologies for batteries include negative electrode lithium replenishing, mainly including wet lithium powder replenishing, dry lithium strip, lithium foil replenishing, etc. However, the lithium replenishing effect of such lithium replenishing methods is not easy to control. For example, the lithium replenishing amount of metal lithium should not be too high, otherwise it is necessary to increase the N/P ratio of the positive and negative electrodes of the battery to reduce the risk of lithium plating in the battery. However, a high N/P ratio may waste a lot of negative electrode materials and reduce the energy density of the battery, which is contrary to the original intention of lithium replenishing, and is not conducive to improve the battery capacity. Therefore, how to precisely control the lithium replenishing amount and the N/P ratio of the battery to realize a controllable design of a battery with a long cycle life has become an urgent problem to be overcome at present.

### SUMMARY

In view of this, the present disclosure provides a lithium-ion battery and an electric vehicle. The lithium-ion battery has a controllable long cycle life and is not prone to lithium plating.

A first aspect of the present disclosure provides a lithium-ion battery, which includes a cell including N battery units, where N is an integer greater than 0, each of the N battery units includes a positive electrode plate, a negative electrode plate, and a separator sandwiched between the positive electrode plate and the negative electrode plate; the positive electrode plate includes a positive electrode current collector and a positive electrode material layer disposed on at least one surface of the positive electrode current collector, and the positive electrode material layer includes a positive electrode active material, a first conductive agent, and a first binder; the negative electrode plate includes a negative electrode current collector and a negative electrode material layer disposed on at least one surface of the negative electrode current collector, and the negative electrode material layer includes a negative electrode active material, a second conductive agent, and a second binder; the lithium-ion battery further includes at least one negative electrode lithium replenishing agent film, where the at least one negative electrode lithium replenishing agent film includes an independent lithium replenishing electrode that includes a current collector and a first metal lithium layer disposed on at least one surface of the current collector, or the at least one negative electrode lithium replenishing agent film includes a second metal lithium layer laminated on a surface of the negative electrode material layer;

an areal density σ of the first metal lithium layer or the second metal lithium layer satisfies the formula I as follows:

$$σ = \frac{N ( α + 1 - η ) {σ}_{2} {c}_{2}}{{nkc}_{3}} ,$$

and a parameter θ satisfies a formula II as follows:

$$θ = \frac{{c}_{2} ( 1 - {ξ}_{2} ) {σ}_{2} ( 1 - {ε}_{2} ) - σ ( 1 + ε ) {c}_{3} k}{{c}_{1} ( 1 + {ξ}_{1} ) {σ}_{1} ( 1 + {ε}_{1} )} ,$$

where α represents a ratio of an amount of pre-stored lithium at the lithium-ion battery with different numbers of cycles to a reversible capacity of the N negative electrode plates; e represents a tolerance of the areal density of the first metal lithium layer or the second metal lithium layer; σ₁ and ε₁ respectively represent an areal density of the positive electrode material layer and a tolerance thereof; σ₂ and ε₂ respectively represent an areal density of the negative electrode material layer and a tolerance thereof; c₁ and ξ respectively represent a gram capacity of the positive electrode material layer and a tolerance thereof; c₂ and ξ₁ respectively represent a gram capacity of the negative electrode material layer and a tolerance thereof; η represents a first coulombic efficiency of the negative electrode active material; n represents a number of first metal lithium layers or second metal lithium layers in the lithium-ion battery; c₃ represents a theoretical gram capacity of a material of the first metal lithium layer or the second metal lithium layer; k represents a correction factor, and k is a constant ranging from 0.5 to 0.95; and θ ranges from 1.0 to 1.3.

In the present disclosure, the lithium replenishing amount of the battery may be controlled by precisely controlling the areal density σ of the first metal lithium layer or the second metal lithium layer, so that a lithium-ion battery with a long cycle life can be controllably designed, and controlling the parameter θ to be in an appropriate range can avoid the risk of lithium plating in the battery, and enables the battery to have a high capacity and cycle performance.

A second aspect of the present disclosure provides an electric vehicle. The electric vehicle includes the lithium-ion battery according to the first aspect of the present disclosure. Therefore, the mile range of the electric vehicle can be improved, and a high safety performance is achieved.

A part of the advantages of the embodiments of the present disclosure will be set forth in the description which follows, and will be obvious from the description, or may be learned by the practice of the embodiments of the present disclosure.

### BRIEF DESCRIPTION OF THE DRAWINGS

FIG. 1a to FIG. 1d are schematic structural diagrams of a lithium-ion battery according to implementations of the present disclosure; and

FIG. 2 is a cycle fading curve of a lithium iron phosphate-graphite system battery at different pre-stored lithium levels according to an embodiment of the present disclosure.

### DETAILED DESCRIPTION

The follows are some embodiments of the present invention, and it should be noted that for a person of ordinary skill in the art, a number of improvements and refinements can be made without departing from the principles of the present invention, and these improvements and refinements are also considered to be within the scope of protection of the present invention.

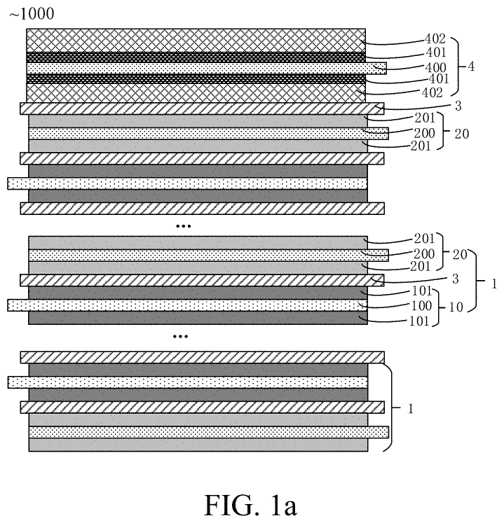

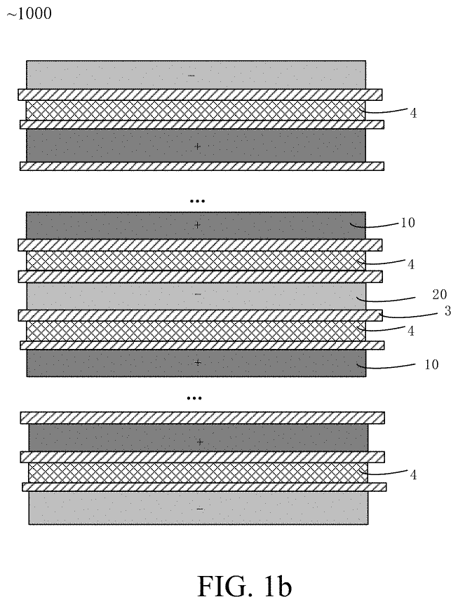

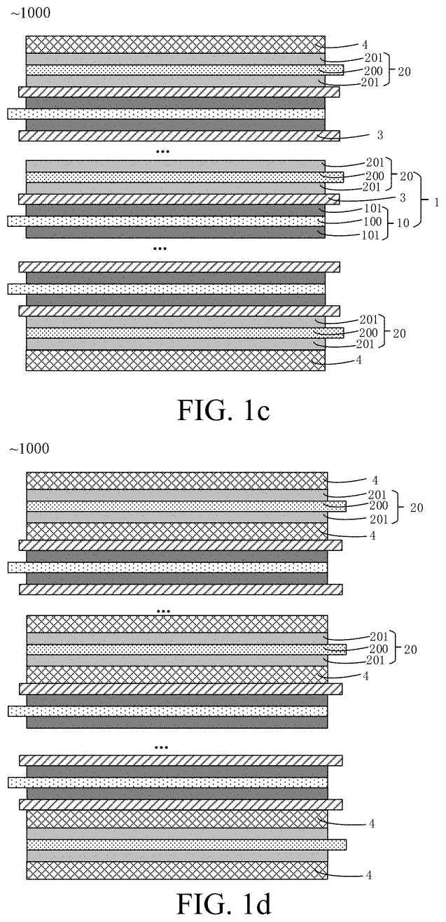

A first aspect of the present disclosure provides a lithium-ion battery 1000. Referring to FIG. 1a to FIG. 1d, the lithium-ion battery 1000 includes a cell formed by stacking N battery units 1. Each of the N battery units 1 includes a positive electrode plate 10, a negative electrode plate 20, and a separator 3 sandwiched between the positive electrode plate 10 and the negative electrode plate 20. Two adjacent battery units 1 are separated by a separator 3. The positive electrode plate 10 includes a positive electrode current collector 100 and a positive electrode material layer 101 arranged/disposed on at least one side surface of the positive electrode current collector 100. The negative electrode plate 20 includes a negative electrode current collector 200 and a negative electrode material layer 201 arranged/disposed on at least one side surface of the negative electrode current collector 200. The positive electrode material layer 101 includes a positive electrode active material, a conductive agent, and a binder. The negative electrode material layer 201 includes a negative electrode active material, a conductive agent, and a binder. The positive electrode material layer 101 may be arranged on one side surface of the positive electrode current collector 100, or may be arranged/disposed on each of two side surfaces of the positive electrode material layer 101. Similarly, the negative electrode material layer 201 may be arranged on one side surface of the negative electrode material layer 201, or may be arranged/disposed on each of two side surfaces of the negative electrode material layer 201.

The lithium-ion battery 1000 further includes at least one negative electrode lithium replenishing agent film 4. The negative electrode lithium replenishing agent film 4 includes a metal lithium layer (e.g., the second metal lithium layer) laminated on a surface of the negative electrode material layer 201, or an independent lithium replenishing electrode including a metal lithium layer (e.g., the first metal lithium layer).

In some implementations of the present disclosure, the negative electrode lithium replenishing agent film 4 may be an independent lithium replenishing electrode. Referring to FIG. 1a, the independent lithium replenishing electrode includes a current collector 400 and a metal lithium layer 402 arranged/disposed on at least one side surface of the current collector. The metal lithium layer 402 may be a lithium elemental layer or a lithium alloy layer. The lithium elemental layer may be in the form of a lithium powder, lithium foil, or lithium strip. The independent lithium replenishing electrode may be arranged/disposed at any position of the cell, for example, placed on an outermost side of the cell (as in FIG. 1a) and/or inserted in the cell (in FIG. 1b, the independent lithium replenishing electrode is inserted between a positive electrode plate 10 and a negative electrode plate 20 that neighboring to each other), but it should be noted that the independent lithium replenishing electrode needs to be separated from the negative electrode plate 20 or the positive electrode plate 10 by a separator 3. The independent negative electrode lithium replenishing agent film 4 can avoid the direct disposition of metal lithium on the negative electrode material layer to cause the metal lithium and the negative electrode material to directly contact and react with each other to generate heat during rolling of the negative electrode plate 20, and prevent the lithium plating when the battery is charged in an insufficient film formation state during pre-lithiation, so as to better realize the controllable release of active lithium ions and realize an ultra-long cycle life. In addition, it should be noted that the independent lithium replenishing electrode needs to be electrically connected with the negative electrode plate 20, for example, a lithium replenishing electrode tab extending from the current collector 400 of the independent lithium replenishing electrode may be electrically connected with a negative electrode tab extending from the negative electrode plate 20.

In some embodiments, further referring to FIG. 1a, in the negative electrode lithium replenishing agent film 4 existing as the independent lithium replenishing electrode, a heat-sensitive semiconductor layer 401 may be sandwiched between the current collector 400 and the metal lithium layer 402. That is, in this case, the negative electrode lithium replenishing agent film 4 includes the current collector 400 and the heat-sensitive semiconductor layer 401 and the metal lithium layer 402 that are sequentially arranged on at least one side surface of the current collector 400. The thermal sensitivity of the heat-sensitive semiconductor layer 401 is embodied in: when the battery is at a normal temperature or a low temperature, a resistance of the heat-sensitive semiconductor layer 401 is as high as 10⁴ Ohm*m², and two ends of the coating are substantially electronically insulated, with a leakage current of less than 0.1 μA/m²; when the temperature of the battery is up to 60° C., the resistance of the coating is less than 10⁻³ Ohm*m², and the two ends of the coating are electronically conductive. In this way, the heat-sensitive semiconductor layer 401 conducts electricity only under the high temperature conditions, so that a path is formed between the metal lithium layer 402 and the current collector 400, and active lithium is released from the metal lithium layer 402 and intercalated in the negative electrode plate of the battery. In addition, the amount of active lithium released may be controlled based on an external voltage.

In some implementations of the present disclosure, the negative electrode lithium replenishing agent film 4 may be in direct contact with the negative electrode material layer 201 (see FIG. 1c and FIG. 1d). In this case, the negative electrode lithium replenishing agent film 4 is a non-independent metal lithium layer, and may be a lithium elemental layer or a lithium alloy layer, where the lithium elemental layer may be in the form of a lithium powder, lithium foil, or lithium strip. In the lithium-ion battery 1000, the metal lithium layer may be located only on surfaces of some negative electrode material layers 201 facing away from the corresponding negative electrode current collectors 200 (see FIG. 1c), or the negative electrode lithium replenishing agent film 4 may be arranged/disposed on surfaces of the negative electrode material layers 201 of all negative electrode plates 20 (see FIG. 1d), etc.

In the present disclosure, an areal density σ of the metal lithium layer in the negative electrode lithium replenishing agent film 4 satisfies the following formula (I), and a parameter θ satisfying the following formula (II) is defined:

$$σ = \frac{N ( α + 1 - η ) {σ}_{2} {c}_{2}}{{nkc}_{3}} , \qquad ( formula I )$$

$$θ = \frac{{c}_{2} ( 1 - {ξ}_{2} ) {σ}_{2} ( 1 - {ε}_{2} ) - σ ( 1 + ε ) {c}_{3} k}{{c}_{1} ( 1 + {ξ}_{1} ) {σ}_{1} ( 1 + {ε}_{1} )} , \qquad ( formula II )$$

where α represents a ratio of an amount of pre-stored lithium required by the lithium-ion battery with different numbers of cycles to a reversible capacity of N negative electrode plates 20, and the reversible capacity is measured in mAh; σ₁ and ε₁ respectively represent an areal density of the positive electrode material layer 101 and a tolerance thereof, σ₂ and ε₂ respectively represent an areal density of the negative electrode material layer 201 and a tolerance thereof, c₁ and ξ₁ respectively represent a gram capacity of the positive electrode material layer 101 and a tolerance thereof, c₂ and ξ₂ respectively represent a gram capacity of the negative electrode material layer 201 and a tolerance thereof, f represents a first coulombic efficiency of the negative electrode active material, η represents a number of metal lithium layers in the lithium-ion battery, c₃ represents a theoretical gram capacity of the material of the metal lithium layer, k represents a correction factor, and k is a constant ranging from 0.5 to 0.95; and θ ranges from 1.0 to 1.3.

In the present disclosure, the lithium replenishing amount of the battery may be controlled by precisely configuring the areal density σ of the metal lithium layer, so that a long cycle life of the lithium-ion battery 1000 can be controllably designed, and configuring the parameter θ to be in an appropriate range can avoid the risk of lithium plating in the battery, and enables the battery to have a high capacity and energy density. The parameter θ can reflect a ratio of remaining vacancies capable of accommodating lithium ions in the negative electrode to vacancies capable of accommodating lithium ions in the positive electrode in the pre-lithiated battery. If the value of 0 is too low, there is a risk of lithium plating on the negative electrode plate 20 during charging. If the value of 0 is too high, the amount of material coated on the negative electrode plate 20 is too large, reducing the energy density of the battery. Through comprehensive consideration in the present disclosure, θ configured in the range of 1.0 to 1.3 can achieve a low risk of lithium plating and a high capacity. For example, 0 may be 1.05, 1.1, 1.12, 1.2, 1.3, etc. In some embodiments, the θ may range from 1.07 to 1.15.

The areal density σ₁ of the positive electrode material layer and the areal density σ₂ of the negative electrode material layer are parameters of the lithium-ion battery, and can be determined in combination with θ. The tolerances Fi, Ea, and F are empirical values, generally measured in %, and may be determined according to the preparation processes of the positive electrode material layer 101, the negative electrode material layer 201, and the metal lithium layer. The above parameters c₁, ξ₁, c₂, ξ₂, and η are measured values, and are obtained by electrochemical testing of coin cells prepared by assembling the positive electrode plate 10 or the negative electrode plate 20 with a lithium metal plate respectively. The tolerances ξ₁ and ξ₂ are also generally measured in %. The areal density σ₁, σ₂, and σ may be measured in g/m², c₁, c₂, and c₃ may be measured in mAh/g, and the parameter c₃ of metal lithium elemental is 3860 mAh/g. In some implementations of the present disclosure, the tolerances ε₁, ε₂, ε, ξ₁ and ξ₂ generally do not exceed 5%, and for example, range from 1% to 3%.

The correction factor k is an empirical value and may be determined according to the form of the metal lithium layer in the negative electrode lithium replenishing agent film 4. For example, when the metal lithium layer is a lithium powder layer obtained by wet coating a metal lithium powder, the value of k generally ranges from 0.5 to 0.85; when the metal lithium layer is a dry-pressed lithium foil or lithium strip, the value of k generally ranges from 0.8 to 0.95; when the metal lithium layer is a lithium alloy, the value of k generally ranges from 0.6 to 0.9.

The parameter α reflects the pre-stored lithium level of the battery. The term “amount of pre-stored lithium” represents a difference between a lithium replenishing capacity of the negative electrode lithium replenishing agent film 4 and an irreversible capacity of the negative electrode plate 20 of the battery. The lithium replenishing capacity of the negative electrode lithium replenishing agent film 4 refers to an amount of lithium that can be deintercalated for the first time. Generally, when the number of cycles required by the battery increases, the value of a also increases. When α is equal to 0, it indicates that the lithium replenishing capacity of the negative electrode lithium replenishing agent film 4 is exactly equal to the irreversible capacity of a plurality of negative electrode plates 20 in the battery. A correspondence between the number of cycles c of the lithium-ion battery and the parameter a will be described in detail in Example 1 below. In some implementations of the present disclosure, a ranges from 0 to 18%. For example, a may be 0, 2%, 4%, 6%, 8%, 10%, 12%, 15%, or 18%. In some implementations of the present disclosure, a ranges from 4% to 15%.

In some implementations of the present disclosure, the metal lithium layer may have a patterned structure. For example, the lithium foil or lithium strip may have a porous structure. The patterned structure is beneficial to the wetting of the metal lithium layer in an electrolyte solution and the release of gas during the formation of an Solid Electrolyte Interphase (SEI) film on the negative electrode in the pre-lithiation process, so as to prevent the detachment of the metal lithium layer from the surface of the negative electrode.

In an implementation of the present disclosure, a plurality of through holes may be provided on the separator 3. The through holes can ensure that lithium ions can successfully intercalate or deintercalate through the separator during rapid charge and discharge of the battery. The through holes may have a porosity of 40% to 50%. The material of the separator may be Polypropylene (PP) or Polyethylene (PE).

In an implementation of the present disclosure, the positive electrode current collector 100, the negative electrode current collector 200, and the current collector 400 of the negative electrode lithium replenishing agent film 4 may include, but are not limited to, a metallic elemental foil or an alloy foil. The metallic elemental foil includes a copper, titanium, aluminum, platinum, iridium, ruthenium, nickel, tungsten, tantalum, gold, or silver foil. The alloy foil includes stainless steel, or an alloy containing at least one of copper, titanium, aluminum, platinum, iridium, ruthenium, nickel, tungsten, tantalum, gold, or silver. In some implementations of the present disclosure, these elements are the main composition of the alloy foil. The positive electrode current collector 100 and/or the negative electrode current collector 200 may be etched or coarsened to form a secondary structure to facilitate effective contact with the corresponding electrode material layer. Generally, the positive electrode current collector 100 is an aluminum foil, and the negative electrode current collector 200 is a copper foil. The current collector 400 of the negative electrode lithium replenishing agent film 4 may be a copper foil.

For the lithium-ion battery, the positive electrode active material may be at least one of lithium iron phosphate, lithium manganese phosphate, lithium manganese iron phosphate, lithium vanadium phosphate, lithium cobalt phosphate, lithium cobaltate (LiCoO₂), lithium manganate, lithium manganese nickelate, lithium nickel manganese oxide, nickel cobalt manganese (NCM), nickel cobalt aluminum (NCA), etc. The negative electrode active material may include at least one of graphite, hard carbon, a silicon-based material (including elemental silicon, silicon alloy, silicon oxide, and silicon-carbon composite material), a tin-based material (including elemental tin, tin oxide, and tin-based alloy), Li₄Ti₅O₂, TiO₂, etc.

In the present disclosure, the conductive agent and the binder are conventional choices in the battery field. For example, the conductive agent may include at least one of carbon nanotubes, carbon black, and graphene. The binder may be selected from one or more of polyvinylidene fluoride (PVDF), polytetrafluoroethylene (PTFE), polyvinyl alcohol (PVA), styrene butadiene rubber (SBR), polyacrylonitrile (PAN), polyimide (PI), polyacrylic acid (PAA), polyacrylate, polyolefin, sodium carboxymethyl cellulose (CMC), and sodium alginate.

In an implementation of the present disclosure, the lithium-ion battery 1000 may further include a battery case and an electrolyte solution. The electrolyte solution and the cell including the battery units 1 and the negative electrode lithium replenishing agent film 4 are packaged in the battery case. The cell is soaked in the electrolyte solution. The battery case may be made of an aluminum-plastic composite film.

The lithium-ion battery provided in the embodiments of the present disclosure has a high capacity, a long cycle life, and a low risk of lithium plating at the same time.

A second aspect of the present disclosure provides an electric vehicle. The electric vehicle includes the lithium-ion battery according to the first aspect of the present disclosure. Therefore, the mile range of the electric vehicle can be improved, and the high safety performance is achieved.

The embodiments of the present disclosure are further described below with reference to a plurality of examples.

### Example 1

A lithium-ion battery had a structure shown in FIG. 1a. A method for preparing the lithium-ion battery included the following steps.

(1) Fabrication of a laminated cell of the battery:

a. A positive electrode plate using lithium iron phosphate as a positive electrode active material and including a positive electrode material layer with an areal density σ₁ of 350 g/m² and a compaction density of 2.4 g/m³ was prepared, and a preparation process was as follows: lithium iron phosphate, carbon nanotubes, and a binder PVDF were weighted according to a mass ratio of 96:2:2, dissolved in a solvent N-methylpyrrolidone (NMP), and fully dispersed to obtain a positive electrode slurry. The positive electrode slurry was coated on a surface of an aluminum foil, dried, rolled, and cut to obtain a positive electrode plate with a positive electrode material layer. A deviation ε₁ (%) of σ₁ was 1%.

b. A negative electrode plate using natural graphite as a negative electrode active material and having a negative electrode material layer with an areal density σ₂ of 206 g/m², a deviation ε₂ of σ₂ being 1%, and a compaction density of 1.5 g/m³ was prepared. A preparation process was as follows: graphite, a conductive agent super P, and a binder SBR were mixed in water according to a weight ratio of 96:2:2 to obtain a negative electrode slurry. The negative electrode slurry was coated on two sides of a copper foil, dried, rolled, and cut to obtain a negative electrode plate with a negative electrode material layer.

c. The positive electrode plate, a separator, and the negative electrode plate were stacked in sequence to obtain a battery unit, where the separator included a PE base film and ceramic layers formed on upper and lower surfaces of the PE base film, the PE base film had a thickness of 40 microns, and a total thickness of the ceramic layers on the two sides was 5 microns; N (N=3) battery units were obtained in a similar manner and stacked together to obtain a laminated cell, and two adjacent battery units are separated by a separator.

(2) Fabrication of an independent lithium replenishing electrode:

Two side surfaces of the current collector 400 (e.g., a copper foil) was coated with a dense semiconductor material having a composition of ZnO:NiO:Al₂O₃:Fe₂O₃=0.3:0.3:0.3:0.1 (by mass), and sintered at a high temperature of 800° C. for 24 h to obtain a heat-sensitive semiconductor layer 401 with a thickness of 80-120 nm. Then, a metal lithium layer 402 with an areal density of 1.98 g/m² was arranged/disposed on the heat-sensitive semiconductor layer 401 for lithium replenishing, to obtain an independent lithium replenishing electrode. The metal lithium layer 402 with an areal density of 1.98 g/m² (e.g., a lithium foil) may be calculated according to the aforementioned formula, which will be described in detail below.

(3) One independent lithium replenishing electrode was arranged/disposed on an outermost side of the laminated cell in step (1), then a tab of the lithium replenishing electrode and a negative electrode tab were welded together, followed by packaging with an aluminum-plastic film to form a pouch battery. Solution of 1.0 mol/L of LiPF₆ in vinyl carbonate (EC):dimethyl carbonate (DMC)=1:1 to 1:5 (volume ratio) was used as an electrolyte solution. Then the electrolyte solution was injected into the battery, and the battery was sealed to obtain a full cell.

After the formation and capacity checking of the assembled full cell of Example 1 were completed at the room temperature, the state of charge (SOC) state of the battery was adjusted to 10%. Then the battery was heated to 60° C., and allowed to stand for 12 h. In this case, the heat-sensitive semiconductor layer conducted electricity, a path was formed between metal lithium and the current collector, and active lithium was released from the independent lithium replenishing electrode and intercalated into the graphite negative electrode. The voltage of the battery was monitored to control and adjust the lithium replenishing amount. When the open-circuit voltage of the battery rose by 0.2 V, the heating was stopped. Then the battery was cooled to 25° C. As such, the pre-lithiation of the full cell was completed. Afterward, the full cell was tested for the battery capacity, cycle performance, etc.

It should be noted that, in Example 1 of the present disclosure, the areal density σ=1.98 g/m² of the metal lithium layer 402 of the independent lithium replenishing electrode is calculated based on the above formulas I and II. The parameter θ was controlled at 1.12, N=3, n=2, the correction factor k was 0.8, c₃ of the lithium metal element was 3860 mAh/g, the gram capacity c₁ of the positive electrode material layer was 148 mAh/g, the tolerance ξ₁ of the gram capacity c₁ was 2%, the gram capacity c₂ of the negative electrode material layer was 330 mAh/g, the tolerance ξ₂ of the gram capacity c₂ was 2%, the first efficiency f was 94%, the pre-stored lithium level a required by the lithium-ion battery when the number of cycles was 3000 was 0%, and ε₁, ε₂, ε were 1%. The parameters c₁, τ₁, c₂, ξ₂, and η were obtained by electrochemical testing of coin cells prepared by assembling the positive electrode plate 10 or the negative electrode plate 20 with a lithium metal plate respectively. Test conditions were as follows: charging and discharging at a constant current of 0.1 C, a voltage window of a coin cell prepared from the positive electrode plate being 2.5 to 3.8 V, and a voltage window of a coin cell prepared from the negative electrode plate being 0.005 to 1.5 V.

In embodiments of the present disclosure, a was obtained by the applicant of the present disclosure according to a mapping relationship between batteries with different pre-stored lithium levels a and the number of cycles c when the capacity retention rates of the batteries drop to 80%, as shown in Table 1 below.

TABLE 1
Empirical comparison table between the number of cycles and α of a
lithium iron phosphate-graphite system battery

| Number of cycles c | 6000 | 7000 | 9000 | 10500 | 12000 | 13000 | 15000 |
|---|---|---|---|---|---|---|---|
| α | 0% | 4% | 6% | 8% | 10% | 13% | 18% |

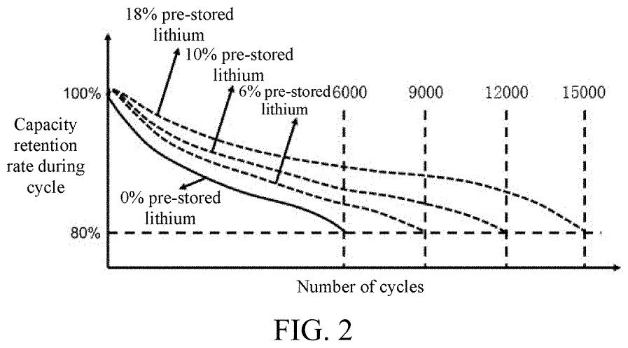

Table 1 above is a cycle fading curve (see FIG. 2) of batteries with different values of α, which is obtained according to the battery system of Example 1. The ordinate (or Y axis) of the cycle fading curve is the capacity retention rate of the battery during the cycle, and the abscissa (or X axis) is the number of cycles. When α=6%, 0=1.12, and the areal density of the graphite negative electrode layer was 206 g/m², the areal density of the metal lithium layer can be calculated as 4.42 g/m² according to the above formulas, and the lithium replenishing battery shown in FIG. 1a was prepared with this areal density. Similarly, when α=10%, the areal density of the metal lithium layer was 6.38 g/m²; and when α=18%, the areal density of the metal lithium layer was 11.48 g/m². These batteries were charged to 3.8 V at a constant current of 0.5 C and a constant voltage, allowed to stand for 10 min, then discharged to 2.0 V at a constant current of 0.5 C, and allowed to stand for 10 min. The above charge-discharge process was cyclically carried out, and the testing was stopped when the capacity retention rate dropped to 80%. The capacity retention rate of each cycle was obtained by dividing the capacity of each cycle by the capacity of the first cycle. As such, the comparison table shown in Table 1 can be obtained.

### Example 2

The lithium-ion battery of Example 2 differs from Example 1 in that: The areal density of the metal lithium layer in the independent lithium replenishing electrode was 4.42 g/m², the areal density of the negative electrode material layer was 230 g/m², and σ=6%.

### Example 3

The lithium-ion battery of Example 3 differs from Example 1 in that: The areal density of the metal lithium layer in the independent lithium replenishing electrode was 6.38 g/m², the areal density of the negative electrode material layer was 249 g/m², and σ=10%.

### Example 4

The lithium-ion battery of Example 4 differs from Example 1 in that: The areal density of the metal lithium layer in the independent lithium replenishing electrode was 11.48 g/m², the areal density of the negative electrode material layer was 299 g/m², and α=18%.

### Example 5

The lithium-ion battery of Example 5 differs from Example 2 in that: two independent lithium replenishing electrodes (n=4) were provided, the areal density of the metal lithium layer was 1.98 g/m², the two independent lithium replenishing electrodes were respectively located on the two outermost side of the entire cell, and the areal density of the negative electrode material layer was 206 g/m².

### Example 6

The lithium-ion battery of Example 6 differs from Example 1 in that: the independent lithium replenishing electrode included a current collector and a metal lithium layer arranged/disposed on each of two side surfaces of the current collector, and did not include a heat-sensitive semiconductor layer.

### Example 7

The lithium-ion battery of Example 7 differs from Example 6 in that: two independent lithium replenishing electrodes (n=4) were provided, the areal density of the metal lithium layer was 0.94 g/m², the two independent lithium replenishing electrodes were respectively located on the two outermost sides of the entire cell, and the areal density of the negative electrode material layer was 196 g/m².

### Example 8

The lithium-ion battery of Example 8 differs from Example 1 in that: the negative electrode lithium replenishing agent film was a lithium foil layer, directly attached to surfaces of two negative electrode material layers of the negative electrode plate on an outermost side of the cell (n=2).

### Example 9

The lithium-ion battery of Example 9 (the structure diagram is shown in FIG. 1c) differs from Example 8 in that: two negative electrode lithium replenishing agent films were provided, which were respectively laminated on surfaces of two negative electrode material layers of the negative electrode plates on two outermost sides of the cell (n=4), the areal density of the lithium foil layer was 0.94 g/m², and the areal density of the negative electrode material layer was 196 g/m².

### Example 10

The lithium-ion battery of Example 10 differs from Example 2 in that: the areal density of the metal lithium layer in the independent lithium replenishing electrode was 4.14 g/m², the areal density of the negative electrode material layer was 215 g/m², and the value of the parameter θ was 1.05.

### Example 11

The lithium-ion battery of Example 11 differs from Example 2 in that: the areal density of the metal lithium layer in the independent lithium replenishing electrode was 4.92 g/m², the areal density of the negative electrode material layer was 256 g/m², and the value of the parameter θ was 1.25.

TABLE 2
Electrochemical testing results of lithium-ion batteries

| | Discharge | Number of | Energy |
|---|---|---|---|
| Examples | capacity/mAh | cycles | density (mAh/g) |
| Example 1 | 646 | 6000 | 219 |
| Example 2 | 652 | 9000 | 213 |
| Example 3 | 649 | 12000 | 207 |
| Example 4 | 650 | 15000 | 194 |
| Example 5 | 663 | 9200 | 224 |
| Example 6 | 635 | 5700 | 216 |
| Example 7 | 642 | 5850 | 221 |
| Example 8 | 630 | 5600 | 215 |
| Example 9 | 636 | 5800 | 220 |
| Example 10 | 652 | 9000 | 218 |
| Example 11 | 651 | 9000 | 205 |

Table 2 summarizes the electrochemical testing results of the batteries of the above examples. A method for testing discharge capacities of the batteries was as follows: at the room temperature, each battery was charged at a constant current of 0.2 C and a constant voltage to 3.8 V, to a cutoff current of 0.05 C, allowed to stand for 10 min, then discharged to 2.0 V at a constant current of 0.2 C, and allowed to stand for 10 min; and the charge-discharge process was repeated three times, to obtain a stable discharge capacity. A method for testing cycle performance of the batteries was as follows: at the room temperature, each battery was charged to 3.8 V at a constant current of 0.5 C, allowed to stand for 10 min, then discharged to 2.0 V at a constant current of 0.5 C, and allowed to stand for 10 min; and the above charge-discharge process was cyclically carried out, and the testing was stopped when the capacity retention rate dropped to 80%. The energy density of the battery was calculated based on the weight of the cell.

As can be seen from Table 2, different cycle life of batteries can be achieved using different amount of pre-stored lithium. A higher pre-stored lithium level a indicates a longer cycle life of the battery. In addition, as can be seen from the comparison between Example 1 and Examples 6 to 9, when the lithium replenishing agent film of the battery was an independent lithium replenishing electrode with a heat-sensitive semiconductor layer, both the capacity and cycle life of the battery reached optimum at the same pre-stored lithium level, and were substantially close to an expected cycle life corresponding to a, while the actual cycle life in Examples 6 to 9 was slightly shorter than the expected cycle life corresponding to a. Moreover, as can be seen from Examples 2, 10 and 11, when the value of the parameter θ was too large, the cycle life and capacity of the battery were not greatly changed, but the energy density of the battery was reduced due to the increase of the weight of the negative electrode material. In the present disclosure, controlling the value of 0 to be within the range of 1.0 to 1.2 can enable the battery to reach a high energy density as much as possible while having a long cycle life.

The above-described embodiments are merely illustrative of several implementations of the present disclosure, and the description does not limit the scope of the present disclosure. It should be pointed out that for those of ordinary skill in the art, variations and improvements can be made without departing from the concept of the present disclosure, which all fall within the protection scope of the present disclosure. Therefore, the protection scope of the present disclosure is defined by the appended claims.

What is claimed is:

1. A lithium-ion battery, comprising a cell comprising N battery units, wherein N is an integer greater than 0, wherein
each of the N battery units comprises a positive electrode plate, a negative electrode plate, and a separator sandwiched between the positive electrode plate and the negative electrode plate;
the positive electrode plate comprises a positive electrode current collector and a positive electrode material layer disposed on at least one surface of the positive electrode current collector, and the positive electrode material layer comprises a positive electrode active material, a first conductive agent, and a first binder;
the negative electrode plate comprises a negative electrode current collector and a negative electrode material layer disposed on at least one surface of the negative electrode current collector, and the negative electrode material layer comprises a negative electrode active material, a second conductive agent, and a second binder;
the lithium-ion battery further comprises at least one negative electrode lithium replenishing agent film, wherein the at least one negative electrode lithium replenishing agent film comprises an independent lithium replenishing electrode that comprises a current collector and a first metal lithium layer disposed on at least one surface of the current collector, or the at least one negative electrode lithium replenishing agent film comprises a second metal lithium layer laminated on a surface of the negative electrode material layer;
an areal density σ of the first metal lithium layer or the second metal lithium layer satisfies formula I as follows:
$$σ = \frac{N ( α + 1 - η ) {σ}_{2} {c}_{2}}{{nkc}_{3}} ,$$
and a parameter θ satisfies formula II as follows:
$$θ = \frac{{c}_{2} ( 1 - {ξ}_{2} ) {σ}_{2} ( 1 - {ε}_{2} ) - σ ( 1 + ε ) {c}_{3} k}{{c}_{1} ( 1 + {ξ}_{1} ) {σ}_{1} ( 1 + {ε}_{1} )} ,$$
wherein α represents a ratio of an amount of pre-stored lithium required by the lithium-ion battery with different numbers of cycles to a reversible capacity of the N negative electrode plates;
ε represents a tolerance of the areal density of the first metal lithium layer or the second metal lithium layer;
σ₁ and ε₁ respectively represent an areal density of the positive electrode material layer and a tolerance thereof,
σ₂ and ε₂ respectively represent an areal density of the negative electrode material layer and a tolerance thereof;
c₁ and ξ₁ respectively represent a gram capacity of the positive electrode material layer and a tolerance thereof,
c₂ and ξ₂ respectively represent a gram capacity of the negative electrode material layer and a tolerance thereof;
η represents a first coulombic efficiency of the negative electrode active material;
n represents a number of first metal lithium layers or second metal lithium layers in the lithium-ion battery;
c₃ represents a theoretical gram capacity of a material of the first metal lithium layer or the second metal lithium layer;
k represents a correction factor, and k is a constant ranging from 0.5 to 0.95; and
θ ranges from 1.0 to 1.3.

2. The lithium-ion battery according to claim 1, wherein α ranges from 0 to 18%.

3. The lithium-ion battery according to claim 1, wherein the first metal lithium layer or the second metal lithium layer comprises a lithium elemental layer or a lithium alloy layer, and the lithium elemental layer comprises a lithium powder layer, a lithium foil, or a lithium strip.

4. The lithium-ion battery according to claim 1, wherein
when the first metal lithium layer or the second metal lithium layer comprises a lithium strip or a lithium foil, k ranges from 0.8 to 0.95;
when the first metal lithium layer or the second metal lithium layer comprises a lithium powder layer, k ranges from 0.5 to 0.85; and
when the first metal lithium layer or the second metal lithium layer comprises a lithium alloy layer, k ranges from 0.6 to 0.9.

5. The lithium-ion battery according to claim 1, wherein the independent lithium replenishing electrode further comprises at least one heat-sensitive semiconductor layer, and the at least one heat-sensitive semiconductor layer is sandwiched between the current collector and the first metal lithium layer or the second metal lithium layer.

6. The lithium-ion battery according to claim 1, wherein the independent lithium replenishing electrode is disposed on the cell and is separated from the positive electrode plate or the negative electrode plate by the separator.

7. The lithium-ion battery according to claim 1, wherein the independent lithium replenishing electrode is inserted between a positive electrode plate and a negative electrode plate adjacent to each other, and/or disposed on an outermost side of the cell.

8. The lithium-ion battery according to claim 1, wherein the first metal lithium layer or the second metal lithium layer comprises a patterned structure.

9. The lithium-ion battery according to claim 1, wherein θ ranges from 1.07 to 1.15.

10. The lithium-ion battery according to claim 2, wherein the first metal lithium layer or the second metal lithium layer comprises a lithium elemental layer or a lithium alloy layer, and the lithium elemental layer comprises a lithium powder layer, a lithium foil, or a lithium strip.

11. The lithium-ion battery according to claim 2, wherein
when the first metal lithium layer or the second metal lithium layer comprises a lithium strip or a lithium foil, k ranges from 0.8 to 0.95;
when the first metal lithium layer or the second metal lithium layer comprises a lithium powder layer, k ranges from 0.5 to 0.85; and
when the first metal lithium layer or the second metal lithium layer comprises a lithium alloy layer, k ranges from 0.6 to 0.9.

12. The lithium-ion battery according to claim 3, wherein
when the first metal lithium layer or the second metal lithium layer comprises a lithium strip or a lithium foil, k ranges from 0.8 to 0.95;
when the first metal lithium layer or the second metal lithium layer comprises a lithium powder layer, k ranges from 0.5 to 0.85; and
when the first metal lithium layer or the second metal lithium layer comprises a lithium alloy layer, k ranges from 0.6 to 0.9.

13. The lithium-ion battery according to claim 2, wherein the independent lithium replenishing electrode further comprises at least one heat-sensitive semiconductor layer, and the at least one heat-sensitive semiconductor layer is sandwiched between the current collector and the first metal lithium layer or the second metal lithium layer.

14. The lithium-ion battery according to claim 4, wherein the independent lithium replenishing electrode further comprises at least one heat-sensitive semiconductor layer, and the at least one heat-sensitive semiconductor layer is sandwiched between the current collector and the first metal lithium layer or the second metal lithium layer.

15. The lithium-ion battery according to claim 2, wherein the independent lithium replenishing electrode is disposed on the cell and is separated from the positive electrode plate or the negative electrode plate by the separator.

16. The lithium-ion battery according to claim 4, wherein the independent lithium replenishing electrode is disposed on the cell and is separated from the positive electrode plate or the negative electrode plate by the separator.

17. The lithium-ion battery according to claim 2, wherein θ ranges from 1.07 to 1.15.

18. The lithium-ion battery according to claim 4, wherein θ ranges from 1.07 to 1.15.

19. The lithium-ion battery according to claim 5, wherein θ ranges from 1.07 to 1.15.

20. An electric vehicle, comprising a lithium-ion battery comprising a cell comprising N battery units, wherein N is an integer greater than 0, wherein
each of the N battery units comprises a positive electrode plate, a negative electrode plate, and a separator sandwiched between the positive electrode plate and the negative electrode plate;
the positive electrode plate comprises a positive electrode current collector and a positive electrode material layer disposed on at least one surface of the positive electrode current collector, and the positive electrode material layer comprises a positive electrode active material, a first conductive agent, and a first binder;
the negative electrode plate comprises a negative electrode current collector and a negative electrode material layer disposed on at least one surface of the negative electrode current collector, and the negative electrode material layer comprises a negative electrode active material, a second conductive agent, and a second binder;
the lithium-ion battery further comprises at least one negative electrode lithium replenishing agent film, wherein the at least one negative electrode lithium replenishing agent film comprises an independent lithium replenishing electrode that comprises a current collector and a first metal lithium layer disposed on at least one surface of the current collector, or the at least one negative electrode lithium replenishing agent film comprises a second metal lithium layer laminated on a surface of the negative electrode material layer;
an areal density σ of the first metal lithium layer or the second metal lithium layer satisfies formula I as follows:
$$σ = \frac{N ( α + 1 - η ) {σ}_{2} {c}_{2}}{{nkc}_{3}}$$
and a parameter θ satisfies formula II as follows:
$$θ = \frac{{c}_{2} ( 1 - {ξ}_{2} ) {σ}_{2} ( 1 - {ε}_{2} ) - σ ( 1 + ε ) {c}_{3} k}{{c}_{1} ( 1 + {ξ}_{1} ) {σ}_{1} ( 1 + {ε}_{1} )}$$
wherein α represents a ratio of an amount of pre-stored lithium at the lithium-ion battery with different numbers of cycles to a reversible capacity of the N negative electrode plates;
ε represents a tolerance of the areal density of the first metal lithium layer or the second metal lithium layer;
σ₁ and ε₁ respectively represent an areal density of the positive electrode material layer and a tolerance thereof;
σ₂ and ε₂ respectively represent an areal density of the negative electrode material layer and a tolerance thereof;
c₁ and ξ₁ respectively represent a gram capacity of the positive electrode material layer and a tolerance thereof;
c₂ and ξ₂ respectively represent a gram capacity of the negative electrode material layer and a tolerance thereof;
η represents a first coulombic efficiency of the negative electrode active material;
n represents a number of first metal lithium layers or second metal lithium layers in the lithium-ion battery;
c₃ represents a theoretical gram capacity of a material of the first metal lithium layer or the second metal lithium layer;
k represents a correction factor, and k is a constant ranging from 0.5 to 0.95; and
θ ranges from 1.0 to 1.3.
